(19) United States
(12) Patent Application Publication
(10) Pub. No.: US 2015/0278194 A1
(43) Pub. Date: Oct. 1, 2015

(54) INFORMATION PROCESSING DEVICE, INFORMATION PROCESSING METHOD AND MEDIUM

(71) Applicant: NEC CORPORATION, Minato-ku, Tokyo (JP)

(72) Inventors: Makoto Terao, Tokyo (JP); Takafumi Koshinaka, Tokyo (JP)

(73) Assignee: NEC Corporation, Minato-ku, Tokyo (JP)

(21) Appl. No.: 14/440,931

(22) PCT Filed: Nov. 7, 2013
(86) PCT No.: PCT/JP2013/006555

§ 371 Date: May 6, 2015

(30) Foreign Application Priority Data
Nov. 7, 2012 (JP) 2012-245003

(51) Int. Cl. G06F 17/27; G06F 17/28

(52) U.S. Cl. CPC G06F 17/2765; G06F 17/28

(57) ABSTRACT

An information processing device according to the present invention includes: a global context extraction unit which identifies a word, a character, or a word string included in data as a specific word, and extracts a set of words included in at least a predetermined range extending from the specific word as a global context; a context classification unit which classifies the global context based on a predetermined viewpoint, and outputs a result of classification; and a language model generation unit which generates a language model for calculating a generation probability of the specific word by using the result of the classification.

### TECHNICAL FIELD

The present invention relates to information processing and, in particular, to information processing on language data.

### BACKGROUND ART

A statistical language model is, for example, a model for computing a generation probability of a word, word string, or character string included in documents to be processed (refer to PLT 1, for example).

One statistical language model may be an “N-gram language model”, which uses the N-gram method.

The N-gram language model assumes that, when a word is defined as a unit of processing, the generation probability of a word at a certain time depends solely on the “N−1” words immediately preceding the word.

When it is assumed that wᵢ is the i-th word and w_{i-N+1}¹⁻¹ is the “N−1” words immediately preceding the word wᵢ, that is, the word string from the “i-N+1”-th to the “i−1”-th words, the generation probability P of the word wᵢ according to the N-gram language model is expressed by P(wᵢ|w_{i-N+1}ⁱ⁻¹). P(wᵢ|w_{i-N+1}ⁱ⁻¹) is a conditional probability (posterior probability) that measures the generation probability of the word wᵢ given that the word string w_{i-N+1}ⁱ⁻¹ has occurred.

The generation probability P (w₁^{m}) of the word string w₁^{m} that includes m words (w₁, w₂, . . . , wₘ) can be obtained by using the conditional probabilities of the respective words as follows:

$$P ( {w}_{1}^{m} ) = {\prod }_{i = 1}^{m} P ( {w}_{i} \vert {w}_{i - N + 1}^{i - 1} ) \qquad [ Equation 1 ]$$

The conditional probability P(wᵢ|w_{i-N+1}ⁱ⁻¹) can be estimated through the use of training data formed by, for example, a word string that is stored for estimates. When it is assumed that C(w_{i-N+1}ⁱ) is a number of occurrences of the word string w_{i-N+1}ⁱ in the training data, and C(w_{i-N+1}ⁱ⁻¹) is a number of occurrences of the word string w_{i-N+1}ⁱ⁻¹ in the training data, the conditional probability P(wᵢ|w_{i-N+1}ⁱ⁻¹) can be estimated by using the maximum likelihood estimation as follows:

$$P ( {w}_{i} \vert {w}_{i - N + 1}^{i - 1} ) = \frac{C ( {w}_{i - N + 1}^{i} )}{C ( {w}_{i - N + 1}^{i - 1} )} \qquad [ Equation 2 ]$$

An N-gram language model having a larger value of N involves a larger amount of calculation. Thus, a typical N-gram language model uses an N value within 2 to 5.

As seen above, N-gram language models take into account a local chain of words only. Thus, N-gram language models cannot give consideration to consistency in a whole sentence or document.

A range greater than the coverage of an N-gram language model, that is, a set of words in a range greater than the immediately preceding 2 to 5 words (for example, immediately preceding several tens of words) is hereinafter referred to as a “global context”. In other words, N-gram language models do not take into consideration any global context.

A trigger model, to the contrary, is a model that considers a global context (refer to NPL 1, for example). The trigger model described in NPL 1 is a language model which assumes that individual words appearing in a global context independently affect the generation probability of a subsequent word. The trigger model retains a degree of influence, which is given by the word wₐ, on the generation probability of the subsequent word w_{b} as a parameter. A pair of these two words (word wₐ and word w_{b}) is called a “trigger pair”. Such trigger pair is hereinafter expressed as “wₐ-->w_{b}”.

For example, a document illustrated in FIG. 14 illustrates how the trigger model is applied. When using the document illustrated in FIG. 14, the trigger model models degrees of influence that the individual words (for example, “space”, “USA”, and “rockets”) in the global context document give on the generation probability of the subsequent word “moon” as independent relationships between words, and incorporates the relationships into a language model.

In order to incorporate the relationships between two words into a language model, the technique described in NPL 1 uses a maximum entropy model.

For example, when assuming that the global context is represented by d, that the subsequent word calculated the generation probability is represented by w, and that a maximum entropy model is used, the generation probability P(w|d) of the subsequent word w is expressed as follows:

$$P ( w \vert d ) = \frac{1}{Z ( d )} exp ( {\sum }_{i = 1}^{M} {λ}_{i} \cdot {f}_{i} ( d , w ) ) \qquad [ Equation 3 ]$$

In this expression, fᵢ(d, w) is a feature function on the i-th trigger pair. M is the total number of feature functions that are prepared. For example, the feature function fᵢ(d, w) for the trigger pair “space-->moon” between the words “space” and “moon” is defined as:

$${f}_{i} ( d , w ) = \{ \begin{matrix}1 & if space ∈ d , w = moon \\ 0 & otherwise\end{matrix} \qquad [ Equation 4 ]$$

λᵢ is a parameter for the model. λᵢ is determined based on training data through the use of the maximum likelihood estimation. Specifically, λᵢ can be calculated through the use of, for example, the iterative scaling algorithm as described in NPL 1.

Z(d) is a normalization term so that Σ_{w}p(w|d)=1, represented by the following expression:

$$Z ( d ) = {\sum }_{w} exp ( {\sum }_{i} {λ}_{i} \cdot {f}_{i} ( d , w ) ) \qquad [ Equation 5 ]$$

Operations of an information processing device for training language by using such trigger model will now be described.

FIG. 13 is a block diagram illustrating an example configuration of an information processing device 9 for training language by using such trigger model.

The information processing device 9 includes a global context extraction unit 910, a trigger feature calculation unit 920, a language model generation unit 930, a language model training data storage unit 940, and a language model storage unit 950.

The language model training data storage unit 940 stores language model training data which is a target for training. Here, the target word is called the word w.

The global context extraction unit 910 extracts a set of words occurring around the word w among the language model training data stored in the language model training data storage unit 940 as a global context. The extracted global context is called the global context d. Then, the global context extraction unit 910 sends the word w and the global context d to the trigger feature calculation unit 920.

The trigger feature calculation unit 920 calculates the function fᵢ(d, w). The trigger feature calculation unit 920 sends the calculated feature function fᵢ(d, w) to the language model generation unit 930.

The language model generation unit 930 generates a language model for calculating the generation probability P(w|d) of the word w by using a maximum entropy model. Then, the language model generation unit 930 sends the generated language model to the language model storage unit 950 so as to store the model.

The language model storage unit 950 stores a language model.

### CITATION LIST

### Patent Literature

[PLT 1] Japanese Unexamined Patent Application Publication No. 10(1988)-319989

### Non Patent Literature

[NPL 1] Ronald Rosenfeld, “A maximum entropy approach to adaptive statistical language modeling”, Computer Speech and Language, Vol. 10, No. 3, pp. 187-228, 1996.

### SUMMARY OF INVENTION

### Technical Problem

The trigger model described in NPL 1 assumes that a word in a global context individually affects the generation probability of the subsequent word (word w). Thus, the trigger model has a problem in that it may sometimes fail to calculate a highly accurate probability of a subsequent word.

This will be explained with reference to the sentence in FIG. 14 as an example.

In the global context d illustrated in FIG. 14, the words “space”, “USA”, “rockets”, “landed”, and “humans” occur. By considering the occurrence of these words, it can be inferred that this global context is highly likely to be related to “moon landing”. Thus, by considering these words in the global context, it is to be inferred that “moon” will highly probably occur as the subsequent word. However, “USA” and “humans”, as single words, are not in a strong relationship with “moon”. Hence, in the trigger model described in NPL 1, the words “USA” and “humans” each have less influence on the generation probability of the subsequent word “moon”. On the other hand, the words “space” and “rockets” are related to “moon landing” to some extent, but they are also related to many topics other than “moon landing”. Accordingly, the word “space” or “rockets” by itself does not significantly improve the generation probability of the word “moon”. As a result, the trigger model estimates a lower generation probability of the word “moon”.

As seen above, the trigger model described in NPL 1 has a problem in that it cannot calculate the generation probability of a subsequent word with high accuracy.

An object of the present invention is to solve the above-described problem and provide an information processing device and information processing method for generating highly accurate language models.

### Solution to Problem

An information processing device according to an aspect of the present invention includes: global context extraction means for identifying a word, a character, or a word string included in data as a specific word, and extracting a set of words included in at least a predetermined range extending from the specific word as a global context; context classification means for classifying the global context based on a predetermined viewpoint, and outputting a result of classification; and language model generation means for generating a language model for calculating a generation probability of the specific word by using the result of the classification.

An information processing method according to an aspect of the present invention includes: identifying a word, a character, or a word string included in data as a specific word, and extracting a set of words included in at least a predetermined range extending from the specific word as a global context; classifying the global context based on a predetermined viewpoint, and outputting a result of classification; and generating a language model for calculating a generation probability of the specific word by using the result of the classification.

A computer readable medium according to an aspect of the present invention, the medium embodying a program, the program causing a computer to execute the processes of: identifying a word, a character, or a word string included in data as a specific word, and extracting a set of words included in at least a predetermined range extending from the specific word as a global context; classifying the global context based on a predetermined viewpoint and outputting a result of classification; and generating a language model for calculating a generation probability of the specific word by using the result of the classification.

### Advantageous Effects of Invention

The present invention makes it possible to generate language models with high accuracy.

### BRIEF DESCRIPTION OF DRAWINGS

FIG. 1 is a block diagram illustrating an example information processing device according to a first exemplary embodiment of the present invention.

FIG. 2 is an explanatory diagram illustrating operations of the global context extraction unit according to the first exemplary embodiment of the present invention.

FIG. 3 is a drawing illustrating example posterior probabilities according to the first exemplary embodiment of the present invention.

FIG. 4 is a flowchart illustrating example operations of an information processing device according to the first exemplary embodiment of the present invention.

FIG. 5 is a block diagram illustrating another example configuration of the information processing device according to the first exemplary embodiment of the present invention.

FIG. 6 is a block diagram illustrating an example configuration of an information processing device according to a second exemplary embodiment of the present invention.

FIG. 7 is a drawing illustrating examples of context classification model training data according to the second exemplary embodiment of the present invention.

FIG. 8 is an explanatory diagram illustrating operations of the context classification model generation unit according to the second exemplary embodiment of the present invention.

FIG. 9 is an explanatory diagram illustrating the storage device according to the second exemplary embodiment of the present invention.

FIG. 10 is a block diagram illustrating an example configuration of an information processing device according to a third exemplary embodiment of the present invention.

FIG. 11 is a block diagram illustrating an example configuration of an information processing device according to a fourth exemplary embodiment of the present invention.

FIG. 12 is a block diagram illustrating an example configuration of an information-processing device according to a fifth exemplary embodiment of the present invention.

FIG. 13 is a block diagram illustrating an example configuration of an information processing device employing a general trigger model.

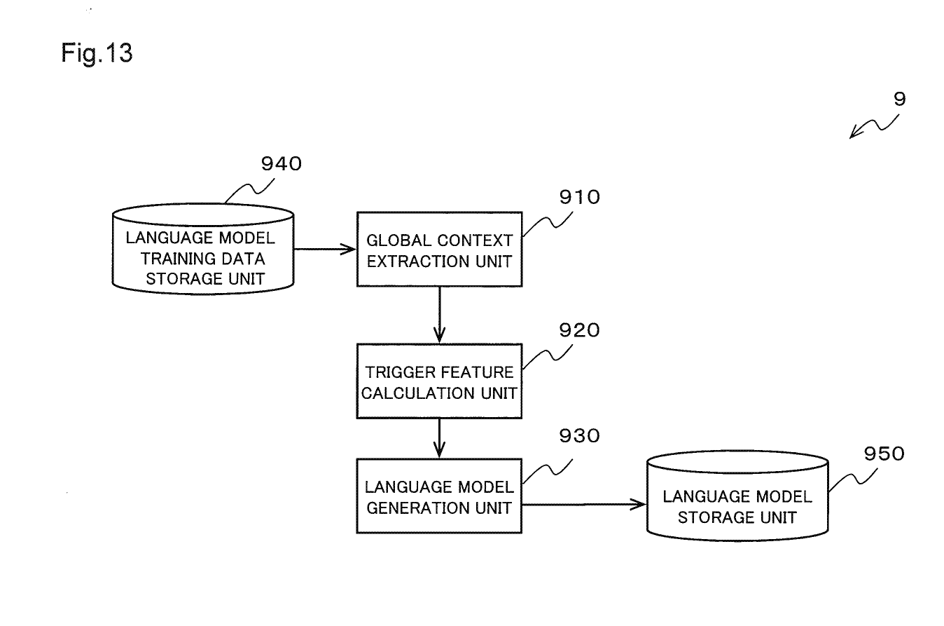

FIG. 14 is a drawing illustrating an example relationship between a global context and a subsequent word.

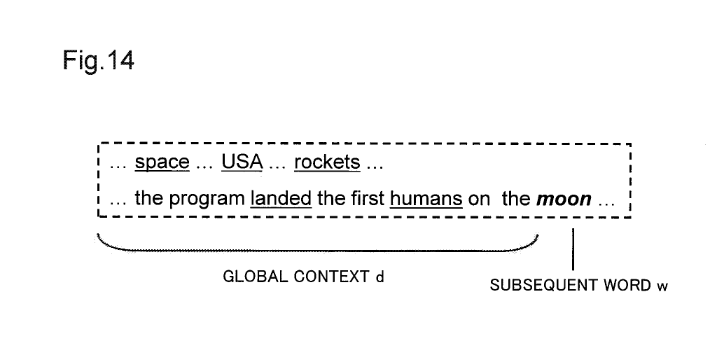

### DESCRIPTION OF EMBODIMENTS

Exemplary embodiments of the present invention will be described with reference to the drawings.

The respective drawings are for explanation of the exemplary embodiments of the present invention. This means the present invention is not limited to illustration on the respective drawings. The same reference numbers are used in the drawings to indicate like components whose duplicate descriptions may be omitted.

The present invention is not limited to any specific language unit (a lexicon unit of a language model) to be processed. For example, a unit to be processed according to the present invention may be a word, a word string, such as a phrase or clause including a plurality of words, or a single character. All of them are collectively called a “word” in the following descriptions.

The present invention is not limited to any specific data to be processed. However, generating a language model with language data may be described as generating a language model through training of language data. Thus, the following descriptions include training a language model as an example processing according to the present invention. Accordingly, the data to be processed according to the present invention may sometimes be described as “language model training data”.

### First Exemplary Embodiment

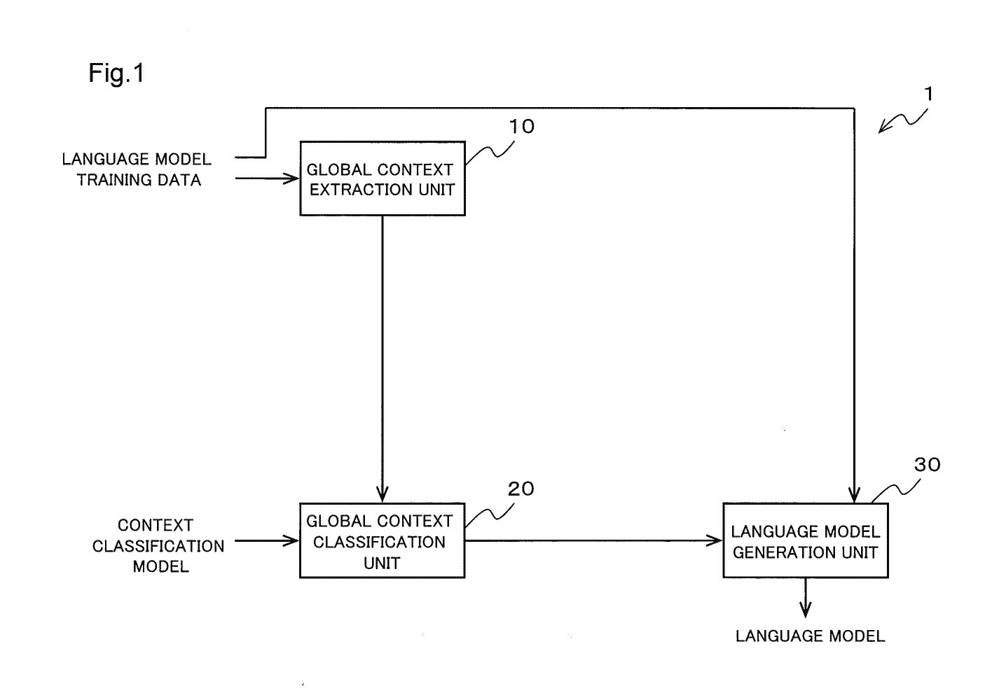

FIG. 1 is a block diagram illustrating an example configuration of an information processing device 1 according to a first exemplary embodiment of the present invention.

The information processing device 1 includes a global context extraction unit 10, a global context classification unit 20, and a language model generation unit 30.

The global context extraction unit 10 receives language model training data, which is the data to be processed according to this exemplary embodiment, and extracts a global context from the language model training data. More specific descriptions are provided below.

The global context extraction unit 10 identifies individual words included in the received language model training data, such individual words being subject to processing, and extracts, as a global context, every set of words occurring around every identified word (hereinafter also called “specific word”).

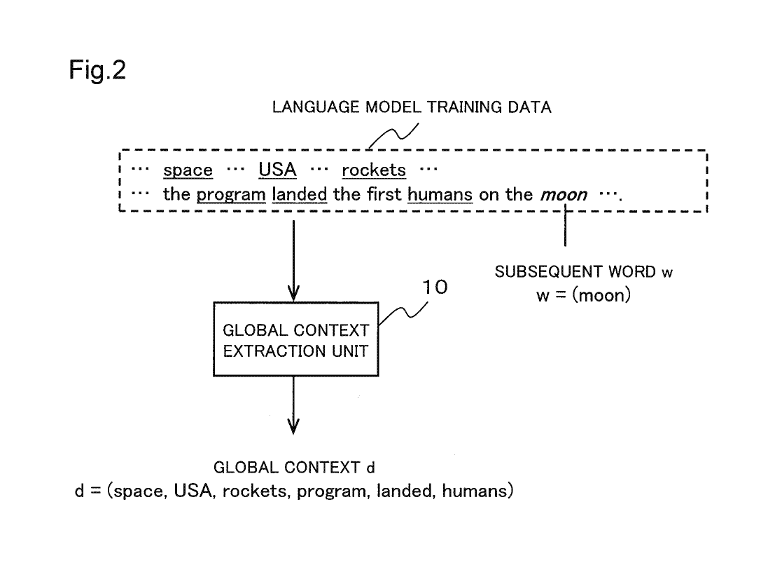

FIG. 2 is an explanatory diagram generally illustrating how the global context extraction unit 10 in the information processing device 1 works.

In FIG. 2, the sentence surrounded by dashed lines represents an example of the language model training data. For example, the global context extraction unit 10 extracts the global context d (“space, USA, rockets, program, landed, humans” in FIG. 2) for a single word (specific word) w (“moon” in FIG. 2) which is included in the language model training data.

There in no particular limitation on a set of words (a global context) to be extracted by the global context extraction unit 10 according to this exemplary embodiment. For example, the global context extraction unit 10 may extract, as a global context, the whole sentence that is a set of words containing the specific word. Alternatively, the global context extraction unit 10 may extract, as a global context, a set of words that fall into a predetermined range (distance) extending from the word immediately before or after the specific word. When the global context extraction unit 10 extracts, as a global context, a set of words that fall into a predetermined range occurring before the specific word, the specific word is a subsequent word to the global context.

Alternatively, the global context extraction unit 10 may extract, as a global context, a set of words that fall into a predetermined range (distance) including words both before and after the specific word. In this case, the distances before and after the specific word may be same or different.

Furthermore, “distance” as used herein is a distance in terms of words in language data. For example, a distance may be the number of words from the specific word or the number of sentences from the sentence containing the specific word.

In the example illustrated in FIG. 2, the global context extraction unit 10 extracts nouns and verbs as part of a global context. However, extractions made by the global context extraction unit 10 of this exemplary embodiment are not limited to them. The global context extraction unit 10 may extract words according to another criterion (for example, a part of speech such as adjectives, or a lexicon set) or may even extract every single word.

The following description refers back to FIG. 1.

The global context extraction unit 10 sends the extracted global context data to the global context classification unit 20.

The global context classification unit 20 divides the global context extracted by the global context extraction unit 10 into classes based on a predetermined viewpoint.

More specifically, the global context classification unit 20 divides the global context into classes by using a context classification model made in advance. The context classification model is a model used by the global context classification unit 20 for classification.

The global context classification unit 20 is allowed to divide the global context into classes based on various viewpoints. For example, to the viewpoint of “topic”, a topic 1 “moon landing”, a topic 2 “space station construction”, and the like are considered as classes of classification.

To the viewpoint of “emotion”, an emotion 1 “pleasure”, an emotion 2 “sorrow”, an emotion 3 “anger”, and the like are considered as classes of classification.

To the viewpoint of “time when document is created”, “January”, “February”, “March”, or “the 19th century”, “the 20th century”, “the 21st century”, and the like are considered as classes of classification. Viewpoints used for classification are not limited to the ones described above.

Classification according to this exemplary embodiment is described below.

In general, classification means dividing things into types (classes) based on a predetermined viewpoint or character. Accordingly, the global context classification unit 20 of this exemplary embodiment may assign a global context any one of the classes that are defined based on a predetermined viewpoint (i.e., hard clustering). For example, a global context may be assigned one topic class “moon landing”.

However, a global context is not always related to one class only. There is a case in which a global context is related to a plurality of classes. Thus, the global context classification unit 20 of this exemplary embodiment may generate information which represents degrees of relation of a global context with a plurality of classes, instead of classifying a global context into one class. As this information, for example, posterior probabilities of individual classes, in a case of making the global context a condition, can be supposed (i.e., soft clustering). For example, probability estimation, such as a probability of the global context belonging to the topics “moon landing” is 0.7, and a probability of the global context belonging to the topics “space station construction” is 0.1, and the like, are also called classification in this exemplary embodiment.

Assigning a global context one class can also be described as that the global context is related to one class. For example, a probability of the global context belonging to the topic “moon landing” at 1.0 means that the global context is assigned the one topic class “moon landing”.

Hence, not only classifying a global context into one class but also generating information which represents relation of the global context with a plurality of classes (e.g., posterior probabilities of individual classes) is hereinafter called “classification”. Accordingly, “classifying a global context based on a predetermined viewpoint” can also be described as “classifying a global context based on a predetermined viewpoint or calculating information which represents relation with a predetermined viewpoint”.

As an example of classification, the following description assumes that the global context classification unit 20 calculates posterior probabilities of individual classes in a case of making the global context a condition. In other words, the global context classification unit 20 calculates posterior probabilities of individual classes at the time when the global context is given by using a global context classification model as a result of classification.

A global context classification model can be generated by, for example, using a large amount of text data containing class information allocated and by training a maximum entropy model, a support vector machine, a neural network, or the like.

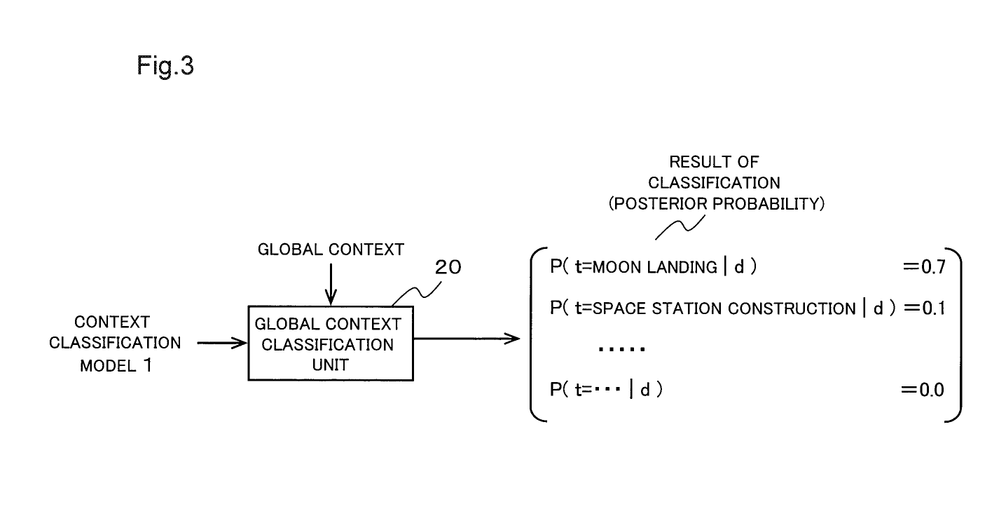

FIG. 3 is a drawing illustrating example a result of classification that has been made on the global context extracted as in FIG. 2 based on the viewpoint of “topic”.

In FIG. 3, t represents a class and d represents a global context.

For example, the posterior probability P (t=moon landing|d) of the class of the topic 1 “moon landing” is 0.7. The posterior probability P (t=space station construction|d) of the class of the topic 2 “space station construction” is 0.1. The posterior probability of the topic k is 0.0.

In this way, the global context classification unit 20 calculates a result of classifying the global context (in this exemplary embodiment, posterior probabilities of the individual classes) corresponding to the specific word to the word (the specific word) identified by the global context extraction unit 10 in language model training data.

The global context extraction unit 10 identifies a plurality of different words in the language model training data as specific words, repetitively extracts a global context for every specific word, and sends the obtained global contexts to the global context classification unit 20. The global context classification unit 20 performs the above-described classification processing on all received global context.

As a specific word, the global context extraction unit 10 may deal with all words in the language model training data as the specific words, may only deal with words belonging to a specific part of speech as the specific words, or may deal with words included in a predetermined lexicon set as the specific words.

The following description refers back to FIG. 1.

The global context classification unit 20 sends a result of classification to the language model generation unit 30.

The language model generation unit 30 generates a language model for calculating generation probabilities of the individual specific words by using the result of classification given by the global context classification unit 20. More specific descriptions are provided below. Generating a language model by using a result of classification may be described as generating a language model based on training with a result of classification. Thus, the language model generation unit 30 may be alternatively called a language model training unit.

The language model generation unit 30 trains a model by using the posterior probabilities of the individual classes calculated by the global context classification unit 20 as features, and generates a language model for calculating generation probabilities of the individual words.

The language model generation unit 30 may use various techniques to train such model. For example, the language model generation unit 30 may use the maximum entropy model already described above.

As seen above, the language model generation unit 30 of this exemplary embodiment generates a language model by using the posterior probabilities of classes which is calculated based on a global context. Accordingly, the language model generation unit 30 can generate a language model that is based on a global context.

For example, as illustrated in FIG. 3, when the posterior probability of the class of the topic 1 “moon landing” is 0.7 and higher than other classes, the language model generation unit 30 can generate a language model that provides a higher generation probability of the specific word w “moon” for “moon landing”.

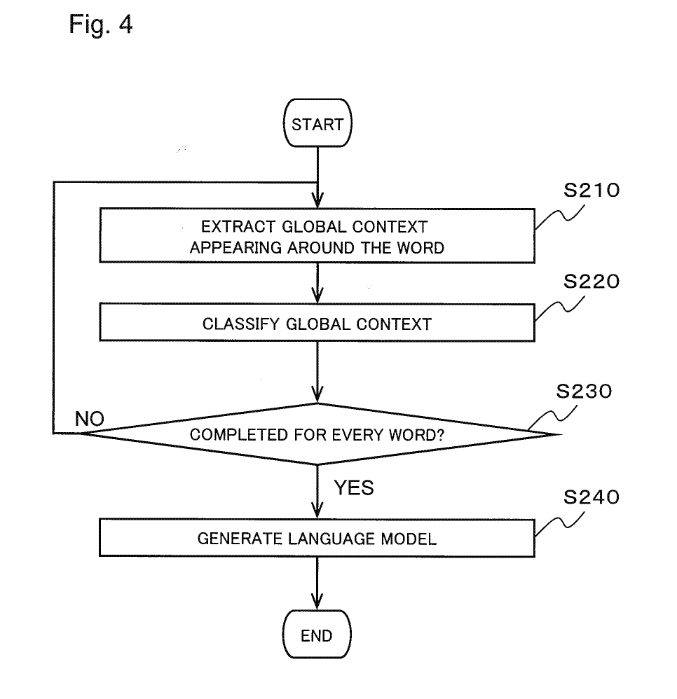

FIG. 4 is a flowchart illustrating example operations of the information processing device 1.

First, the global context extraction unit 10 of the information processing device 1 extracts, as a global context, a set of words around a certain word (specific word) in the language model training data in the form of global context data (Step S210).

Next, the global context classification unit 20 in the information processing device 1 classifies the global context by using a context classification model (Step S220).

The information processing device 1 determines whether or not processes for all the words in the language model training data have been completed (Step S230). The words subject to processes for the information processing device 1 are not necessarily all the words contained in the language model training data. The information processing device 1 may use some certain words in the language model training data as specific words. In this case, the information processing device 1 determines whether or not processes for all the specific words, which are contained in a predetermined lexicon set, have been completed.

When processes for all the words have not been completed (No in Step S230), the information processing device 1 returns to Step S210 and performs processes for the next specific word.

When processes for all the words have been completed (Yes in Step S230), the language model generation unit 30 of the information processing device 1 generates a language model for calculating generation probabilities of the individual specific words by using the result of classification of global contexts (e.g., posterior probabilities of classes) (Step S240).

The information processing device 1 configured as above can achieve the effect of generating a language model with high accuracy.

The reasons are as follows. The information processing device 1 extracts a global context from language model training data. Next, the information processing device 1 classifies the extracted global context by using a context classification model. Then, the information processing device 1 generates a language model based on the result of classification. Accordingly, the information processing device 1 can generate a language model based on a global context.

This effect is described below with reference to the specific example in FIG. 2. Because “space”, “rockets”, “program”, “landed”, and the like occur in the global context for the specific word “moon”, in this exemplary embodiment, the global context classification unit 20 calculates a higher value as the posterior probability of the class “moon landing”. The language model generation unit 30 generates a model for calculating generation probabilities of words by using posterior probabilities of classes as features. Consequently, the language model generated by this exemplary embodiment can calculate the probability of occurrence of the word “moon” as subsequent to the global context in FIG. 2 at a higher value.

In a trigger model, “USA” and “humans” each have little influence on the generation probability of “moon”. However, in this exemplary embodiment, it can be said that these two words contribute to an improved generation probability of “moon” by increasing the posterior probability of the “moon landing” class.

The information processing device 1 of this exemplary embodiment further can achieve the effect of reducing deterioration in estimate accuracy for a subsequent word in case the global context contains an error.

The reasons are as follows. The information processing device 1 of this exemplary embodiment extracts a global context of a predetermined size. Thus, even though a few errors are contained in the plurality of words in the global context, a ratio of the errors to the global context come to be small, and therefore the result of classification of the global context does not vary greatly.

### Modified Example

The configuration of the information processing device 1 according to this exemplary embodiment is not limited to the configuration described above. The information processing device 1 may divide each element into a plurality of elements. For example, the information processing device 1 may divide the global context extraction unit 10 into a receiving unit for receiving language model training data, a processing unit for extracting a global context, and a transmission unit for sending a global context, all of which units are not illustrated.

Alternatively, the information processing device 1 may combine one or more elements into one component. For example, the information processing device 1 may combine the global context extraction unit 10 and the global context classification unit 20 into one component. Furthermore, the information processing device 1 may configure individual elements in a separate device connected to a network (not illustrated).

Furthermore, the configuration of the information processing device 1 of this exemplary embodiment is not limited to those described above. The information processing device 1 may be implemented in the form of a computer which includes a central processing unit (CPU), read only memory (ROM), and random access memory (RAM).

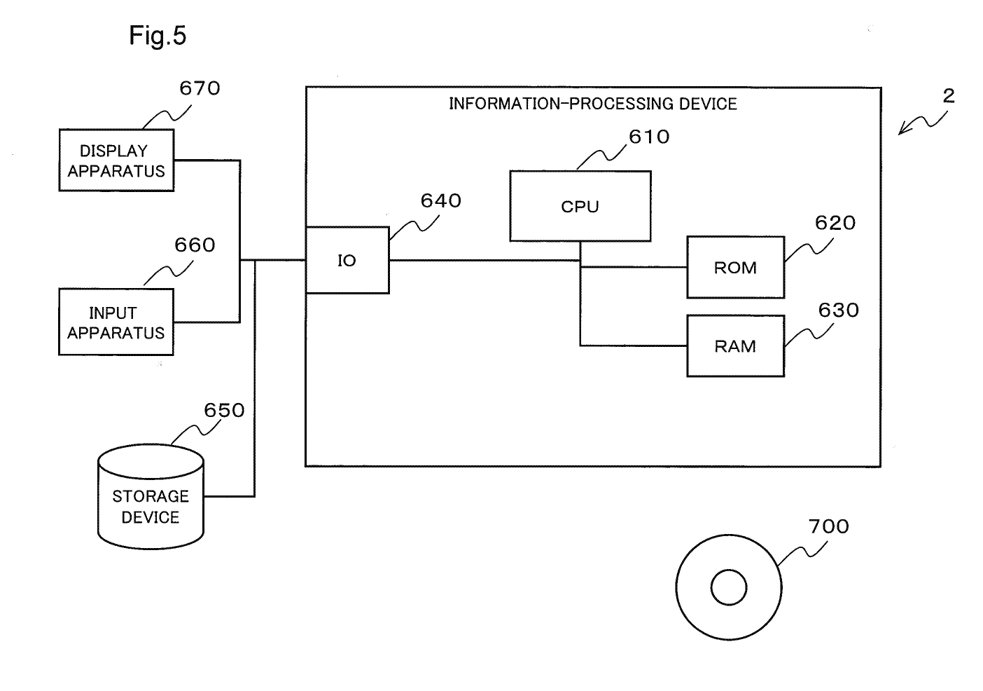

FIG. 5 is a block diagram illustrating an example configuration of an information processing device 2 which represents another configuration of this exemplary embodiment.

The information processing device 2 includes a CPU 610, ROM 620, RAM 630, IO (input/output) 640, a storage device 650, an input apparatus 660, and a display apparatus 670, and constructs a computer.

The CPU 610 reads out a program from the ROM 620, or from the storage device 650 via the IO 640. Based on the read out program, the CPU 610 executes individual functions of the global context extraction unit 10, the global context classification unit 20, and the language model generation unit 30 illustrated in FIG. 1. When executing these functions, the CPU 610 uses the RAM 630 and the storage device 650 as temporary storages. In addition, the CPU 610 receives input data from the input apparatus 660 and displays the data on the display apparatus 670 via the IO 640.

The CPU 610 may read a program contained in the storage medium 700 which stores a program as computer readable by using a storage medium reading device (not illustrated). Alternatively, the CPU 610 may receive a program from an external device via a network (not illustrated).

The ROM 620 stores a program to be executed by the CPU 610 and fixed data. The ROM 620 is, for example, a programmable ROM (P-ROM) or a flash ROM.

The RAM 630 temporarily stores a program to be executed by the CPU 610 and data. The RAM 630 is, for example, a dynamic RAM (D-RAM).

The IO 640 mediates data between the CPU 610, and, the storage device 650, the input apparatus 660, and the display apparatus 670. The IO 640 is, for example, an IO interface card.

The storage device 650 stores a program and data to be stored for a long time in the information processing device 2. Additionally, the storage device 650 may execute as a temporary storage device for the CPU 610. Furthermore, the storage device 650 may store a part or the whole of information, such as language model training data, illustrated in FIG. 1 according to this exemplary embodiment. The storage device 650 is, for example, a hard disk device, a magneto optical disk device, a solid state drive (SSD), or a disk array device.

The input apparatus 660 is an input unit for receiving input instructions from an operator of the information processing device 2. The input apparatus 660 is, for example, a keyboard, mouse, or touch panel.

The display apparatus 670 is a display unit for the information processing device 2. The display apparatus 670 is, for example, a liquid crystal display.

The information processing device 2 configured as above can achieve the effects similar to those of the information processing device 1.

This is because the CPU 610 in the information processing device 2 can execute operations similar to those of the information processing device 1 based on a program.

### Second Exemplary Embodiment

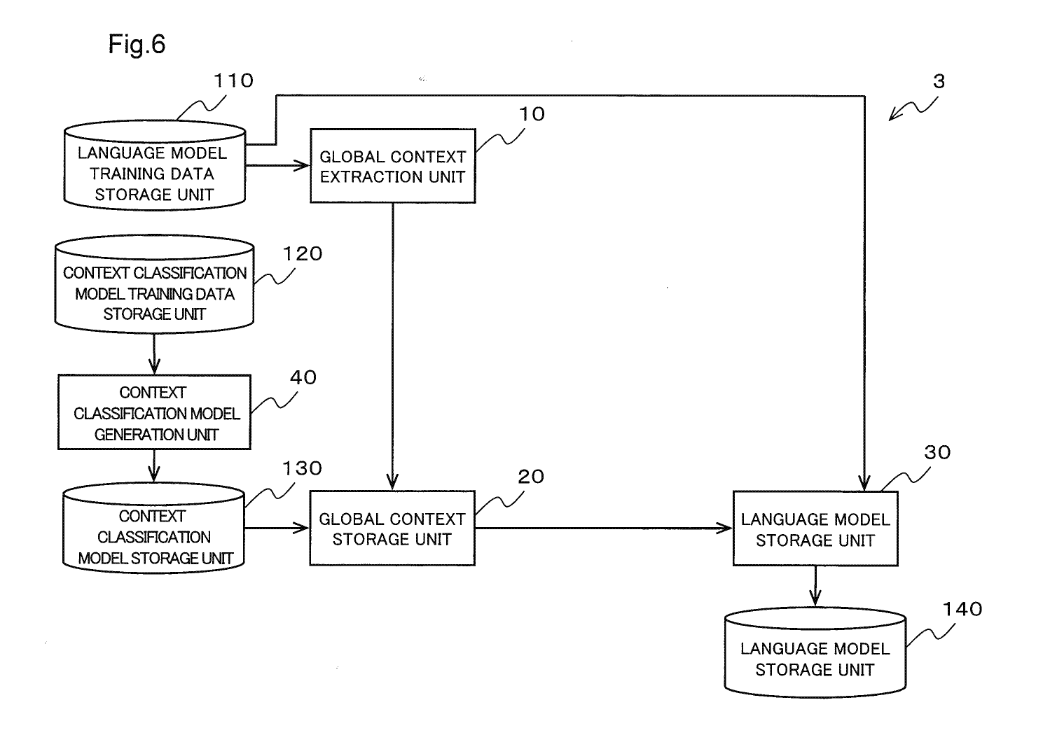

FIG. 6 is a block diagram illustrating an example configuration of an information processing device 3 according to a second exemplary embodiment of the present invention.

The information processing device 3 includes the global context extraction unit 10, the global context classification unit 20, the language model generation unit 30, a context classification model generation unit 40, a language model training data storage unit 110, a context classification model training data storage unit 120, a context classification model storage unit 130, and a language model storage unit 140.

The global context extraction unit 10, the global context classification unit 20, and the language model generation unit 30 are the same as those of the first exemplary embodiment. Thus, descriptions overlapping with the first exemplary embodiment are omitted as appropriate.

The language model training data storage unit 110 stores “language model training data” which is the data to be processed for the information processing device 3 to generate a language model. As described above, the language model training data is not necessarily limited to any specific data format and may be in the form of word strings or character strings.

The language model training data stored in the language model training data storage unit 110 is not limited to any specific content. For example, the language model training data may be a newspaper story, an article published on the Internet, minutes of a meeting, sound or video content, or transcribed text. In addition, the language model training data may be not only above-mentioned primary data but also secondary data obtained by processing primary data. Furthermore, the language model training data according of this exemplary embodiment may be data that is expected to closely represent the target of the language model and selected from above data.

The global context extraction unit 10 receives the language model training data from the language model training data storage unit 110. Other operations of the global context extraction unit 10 are the same as those of the first exemplary embodiment, and thus their detailed descriptions are omitted.

The context classification model training data storage unit 120 stores in advance the “context classification model training data” for training a context classification model. The context classification model training data is not limited to any specific data format. A plurality of documents (sets of words) to which class information is allocated may be used as the context classification model training data.

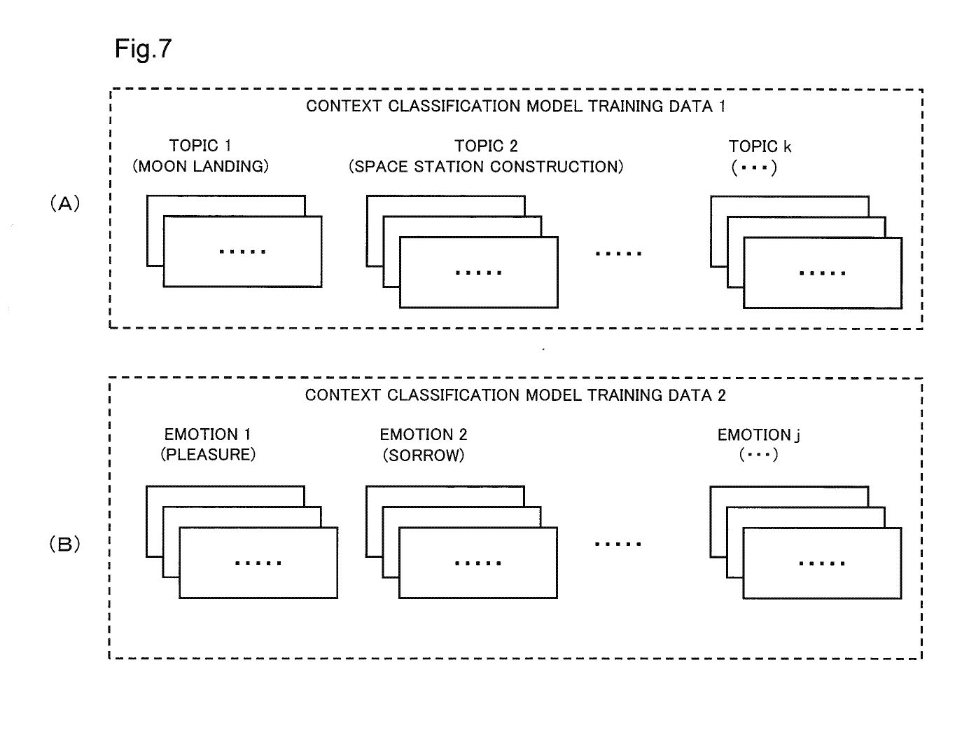

FIG. 7 illustrates some examples of context classification model training data. FIG. 7 (A) represents the context classification model training data under the classification viewpoint of “topic”. Each of the rectangle frames under topics, such as the topic 1 “moon landing” and the topic 2 “space station construction”, represents a document (a set of words).

Thus, the context classification model training data is generated by giving a plurality of documents the topic class information to which the documents belongs.

The context classification model generation unit 40 generates a context classification model to be used by the global context classification unit 20, based on the context classification model training data stored in the context classification model training data storage unit 120. Because the context classification model generation unit 40 generates a context classification model based on the context classification model training data, the context classification model generation unit 40 can be described as a context classification model training unit.

The context classification model generation unit 40 generates a model for calculating conditional posterior probabilities of individual classes at the time when an optional set of words are given as a context classification model. For example, a maximum entropy model, a support vector machine, or a neural network can be used as such model. As features for the model, any word included in the set of words, a part of speech, or the number of occurrences such as an N-gram can be used.

When training data from the classification viewpoint of “emotion” as illustrated in FIG. 7 (B) is prepared as the context classification model training data, the context classification model generation unit 40 can generate a context classification model for classifying a global context from the viewpoint of “emotion”. Viewpoints for giving classes to training data, as the context classification model training, are not limited to “topic”, “emotion”, and “time” as described above.

In addition, a plurality of documents (sets of words) with no class information allocated may also be used as the context model training data. When the context classification model generation unit 40 receives the context model training data which is a set of words with no class information allocated, the context classification model generation unit 40 needs only to operate as described below.

First, the context classification model generation unit 40 clusters the words or documents included in the context classification model training data, and combines them into a plurality of clusters (unsupervised clustering). A clustering technique used by the context classification model generation unit 40 is not limited in particular. For example, the context classification model generation unit 40 may use the agglomerative clustering or the k-means method as a clustering technique. The context classification model generation unit 40 can train a context classification model by regarding each cluster classified like this as a class.

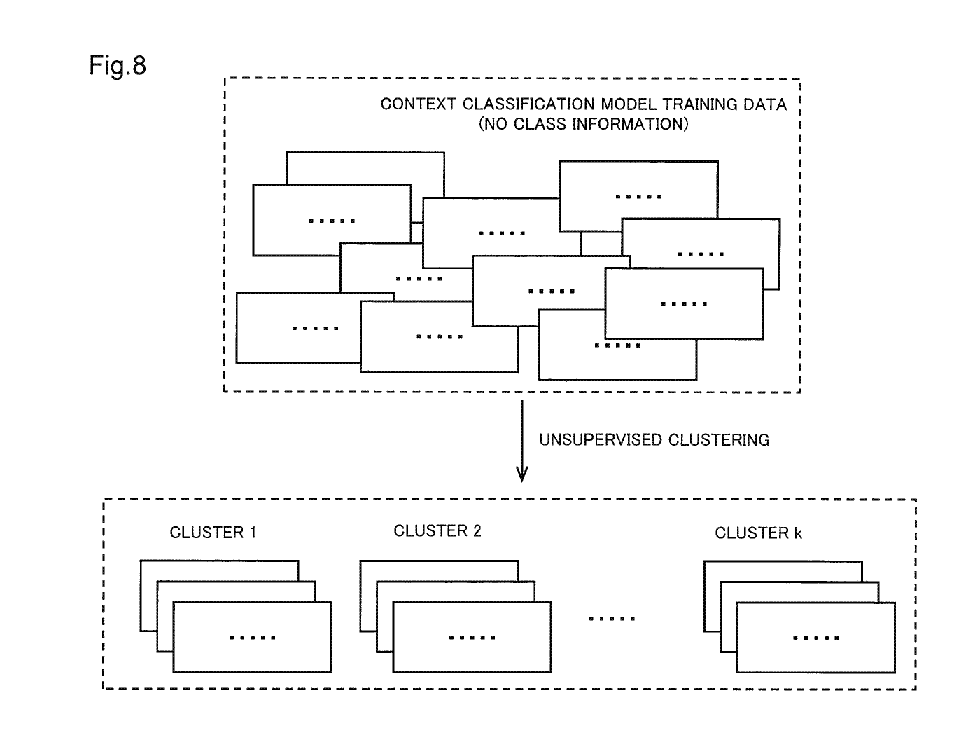

FIG. 8 is a schematic diagram illustrating clustering operations of the context classification model generation unit 40. The context classification model generation unit 40 divides the context classification model training data having no class information into a plurality of classes (cluster 1, cluster 2, . . . , cluster 1) by using, for example, the agglomerative clustering.

When given class information to the context classification model training data by such unsupervised clustering, viewpoints of classification are not given manually but automatically generated by the unsupervised clustering.

As the context classification model training data, the context classification model generation unit 40 may use different data from the language model training data. For example, if when the context classification model generation unit 40 generates a language model of a different domain, the context classification model generation unit 40 may use new data matching the domain as the language model training data, and existing data as the context classification model training data. When given class information to a plurality of documents in the context classification model training data, it is costly to give such class information manually every time when an applied domain of the language model changes. In such cases, procedures for this exemplary embodiment can be carried out by preparing new data for language model training data only. The context classification model training data and the language model training data may be common.

The following description refers back to FIG. 6.

The context classification model generation unit 40 sends the generated context classification model to the context classification model storage unit 130 so as to store the model.

The context classification model storage unit 130 stores the context classification model generated by the context classification model generation unit 40.

The global context classification unit 20 classifies a global context in the same way as in the first exemplary embodiment, based on the context classification model stored in the context classification model storage unit 130.

The information processing device 3 need not to generate a context classification model at every time when the language model training data is processed. The global context classification unit 20 of the information processing device 3 may apply the same context classification model to different language model training data.

The information processing device 3 may make the context classification model generation unit 40 generate a context classification model if necessary. For example, when the information processing device 3 receives context classification model training data via a network (not illustrated), the information processing device 3 may make the context classification model generation unit 40 generate a context classification model.

The global context classification unit 20 sends a result of classification to the language model generation unit 30.

The language model generation unit 30 generates a language model based on the result of classification. Because the language model generation unit 30 is the same as in the first exemplary embodiment without storing the generated language model into the language model storage unit 140, detailed descriptions are omitted.

The language model storage unit 140 stores the language model generated by the language model generation unit 30.

The information processing device 3 of this exemplary embodiment configured as above can achieve the effect of generating a language model with higher accuracy, in addition to the effect of the first exemplary embodiment.

The reasons are as follows. The context classification model generation unit 40 of the information processing device 3 of this exemplary embodiment generates a context classification model based on context classification model training data. Then, the global context classification unit 20 uses the generated context classification model. Accordingly, the information processing device 3 can perform processing using a suitable context classification model.

In particular, as illustrated in FIG. 7, when a document (set of words) given class information is used as the context classification model training data, because the accuracy of a context classification model is improved, the accuracy of a training model that is trained with a classification result as features is also improved.

Similarly to the information processing device 2 illustrated in FIG. 5, the information processing device 3 of this exemplary embodiment may be implemented by a computer which includes the CPU 610, the ROM 620, and the RAM 630.

In this case, the storage device 650 may perform as each of the storage units of this exemplary embodiment.

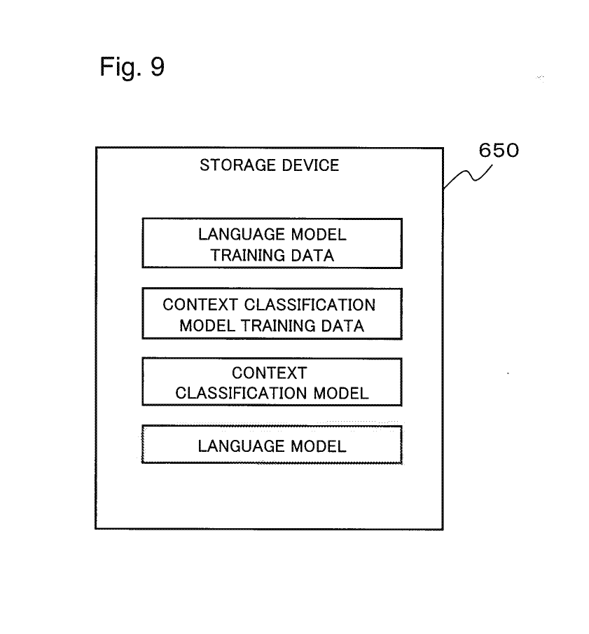

FIG. 9 illustrates information stored in the storage device 650 when the storage device 650 performs as the language model training data storage unit 110, the context classification model training data storage unit 120, the context classification model storage unit 130, and the language model storage unit 140 of this exemplary embodiment.

### Third Exemplary Embodiment

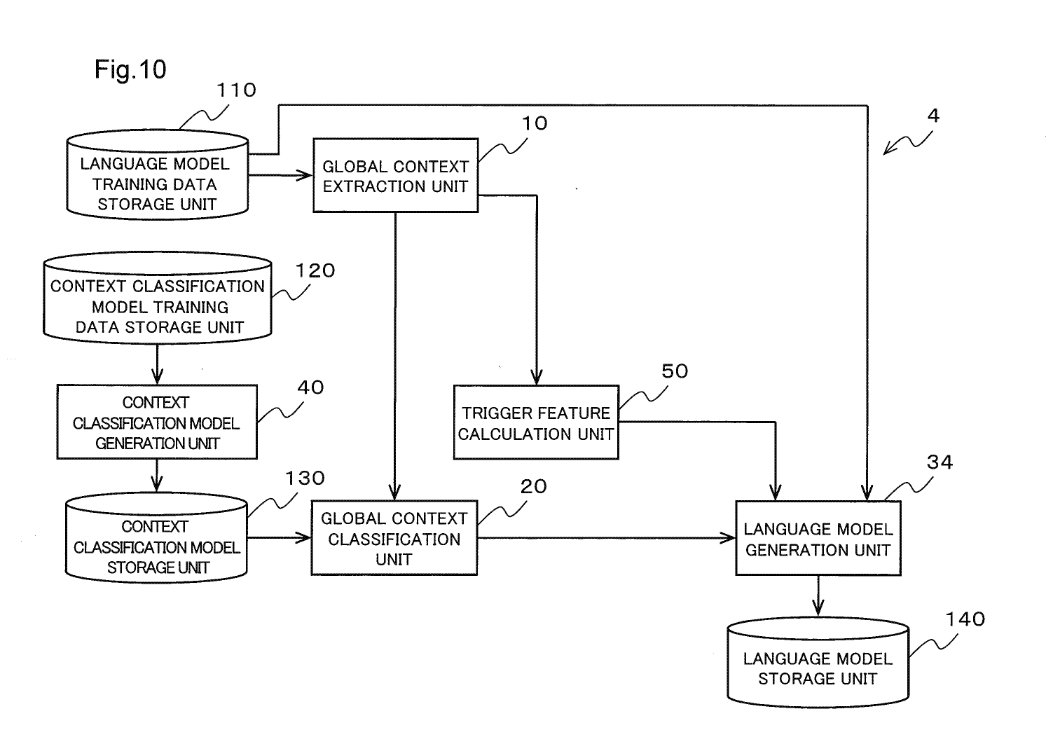

FIG. 10 is a block diagram illustrating an example configuration of an information processing device 4 according to a third exemplary embodiment of the present invention.

The information processing device 4 is different at the point in that the information processing device 4 includes a trigger feature calculated unit 50 in addition to the configuration of the information processing device 3 of the second exemplary embodiment, and a language model generation unit 34 instead of the language model generation unit 30.

Because other elements of the information processing device 4 are the same as in the information processing device 3, the elements and operations specific to this exemplary embodiment are described below, while descriptions similar to the second exemplary embodiment are omitted. Similarly to the information processing device 2 illustrated in FIG. 5, the information processing device 4 of this exemplary embodiment may be implemented by a computer which includes the CPU 610, the ROM 620, and the RAM 630.

The trigger feature calculation unit 50 receives a global context from the global context extraction unit 10, and extracts a trigger pair from a word in the global context to a specific word. By using the example in FIG. 2, the trigger feature calculation unit 50 extracts, for example, the trigger pairs “space-->moon” and “USA-->moon”.

Then, the trigger feature calculation unit 50 calculates a feature function for the extracted trigger pair.

When the trigger pair from the word a to the word b is expressed as “a-->b”, the feature function for the trigger pair from the word a to the word b can be obtained by the following equation.

$${f}_{a \to b} ( d , w ) = \{ \begin{matrix}1 & if a ∈ d , w = b \\ 0 & otherwise\end{matrix} \qquad [ Equation 6 ]$$

The trigger feature calculation unit 50 sends the calculated feature function for the trigger pair to the language model generation unit 34.

The language model generation unit 34 generates a language model by using the feature function from the trigger feature calculation unit 50 in addition to the result of classification from the global context classification unit 20.

The information processing device 4 of the third exemplary embodiment configured as above can achieve the effect of further improving the accuracy of generation probabilities of words, in addition to the effect of the information processing device 3 of the second exemplary embodiment.

The reasons are as follows.

The feature function for the trigger pair represents a relationship (e.g., strength of co-occurrence) between the two words of the trigger pair.

Thus, the language model generation unit 34 of the information processing device 4 generates a language model for estimating generation probabilities of words by considering a relationship between specific two words being likely to co-occur in addition to the result of classification of a global context.

### Fourth Exemplary Embodiment

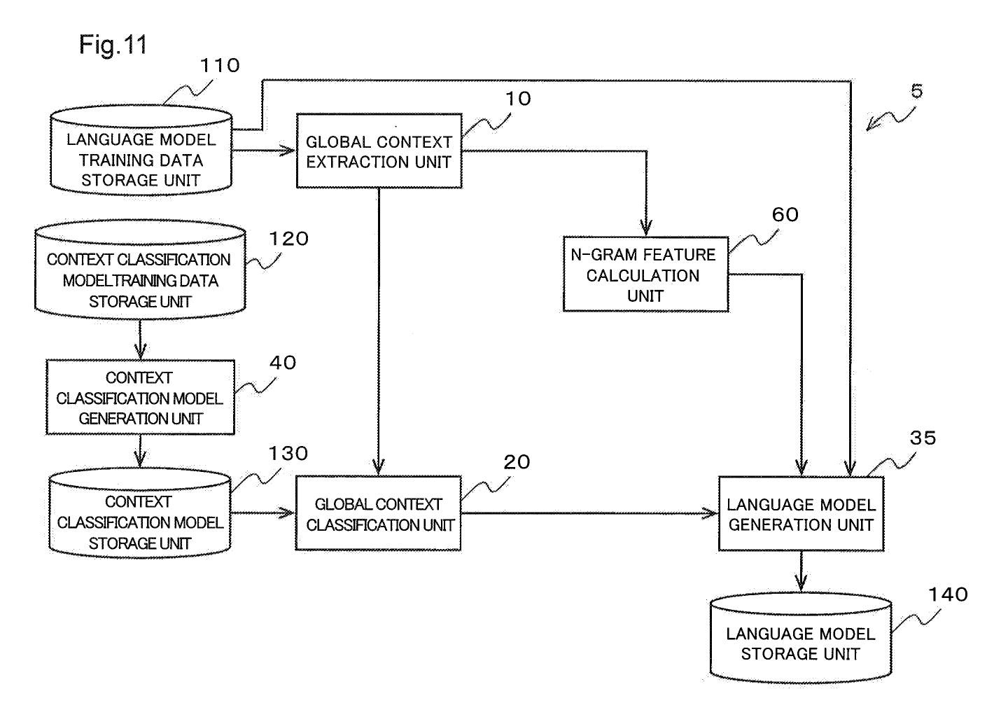

FIG. 11 is a block diagram illustrating an example configuration of an information processing device 5 according to a fourth exemplary embodiment of the present invention.

The information processing device 5 is different at the point in that the information processing device 5 includes an N-gram feature calculation unit 60 in addition to the configuration of the information processing device 3 of the second exemplary embodiment, and a language model generation unit 35 instead of the language model generation unit 30.

Because other elements of the information processing device 5 are the same as in the information processing device 3, the elements and operations specific to this exemplary embodiment are described below, while descriptions similar to the second exemplary embodiment are omitted. Similarly to the information processing device 2 illustrated in FIG. 5, the information processing device 5 of this exemplary embodiment may be implemented by a computer which includes the CPU 610, the ROM 620, and the RAM 630.

The N-gram feature calculation unit 60 receives a global context from the global context extraction unit 10, and extracts several words, as an N-gram, immediately preceding the specific word.

Then, the N-gram feature calculation unit 60 calculates a feature function for the extracted word string.

When a word is wᵢ and let a word string formed by N−1 words immediately preceding the word is w_{i-N+1}ⁱ⁻¹, the feature function for the N-gram can be obtained by the following equation.

$${f}_{x 1 , x 2 , … , xN} ( {w}_{1}^{i - 1} , {w}_{i} ) = \{ \begin{matrix}1 & if {w}_{i - N + 1}^{i - 1} = {x}_{1}^{N - 1} , {w}_{i} = {x}_{N} \\ 0 & otherwise\end{matrix} \qquad [ Equation 7 ]$$

The N-gram feature calculation unit 60 sends the calculated feature function for the N-gram to the language model generation unit 35.

The language model generation unit 35 generates a language model by using the feature function from the N-gram feature calculation unit 60 in addition to the result of classification from the global context classification unit 20.

The information processing device 5 of the fourth exemplary embodiment configured as above can achieve the effect of further improving the accuracy of generation probabilities of words, in addition to the effect of the information processing device 3 of the second exemplary embodiment.

The reasons are as follows.

The feature function for an N-gram is a function that considers local constraints on a chain of words.

Thus, the language model generation unit 35 of the information processing device 5 generates a language model for estimating generation probabilities of words by considering local constraints on words in addition to the result of classification of a global context.

### Fifth Exemplary Embodiment

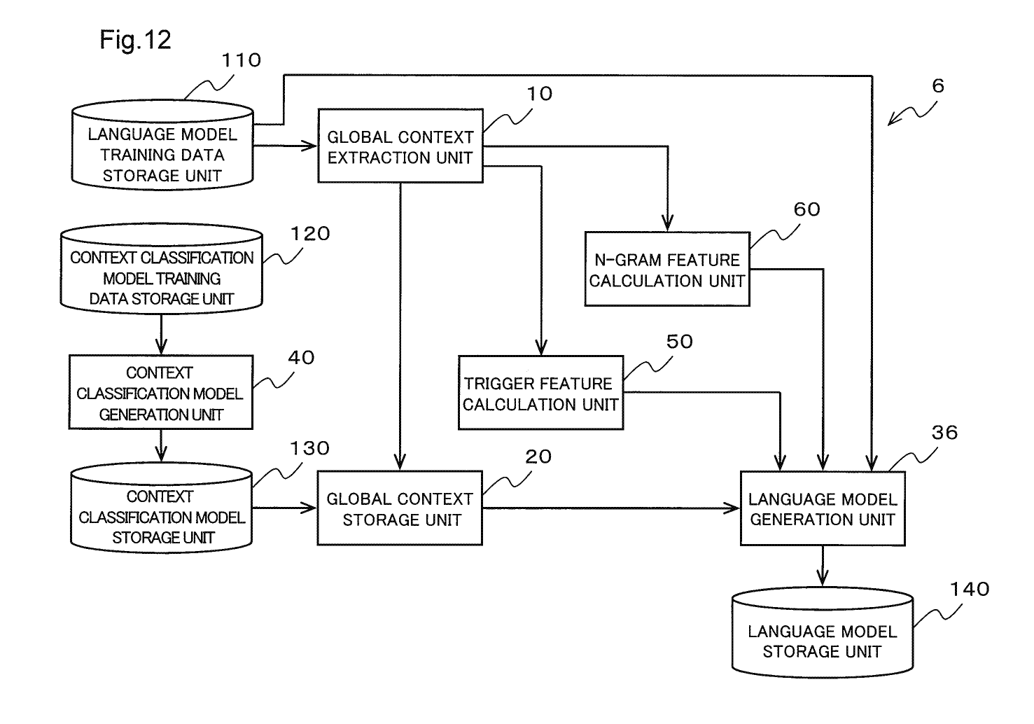

FIG. 12 is a block diagram illustrating an example configuration of the information processing device 6 according to a fifth exemplary embodiment of the present invention.

The information processing device 6 is different at the point in that the information processing device 6 includes a trigger feature calculation unit 50 similar to that of the third exemplary embodiment and an N-gram feature calculation unit 60 similar to that of the fourth exemplary embodiment in addition to the configuration of the information processing device 3 of the second exemplary embodiment, and a language model generation unit 36 instead of the language model generation unit 30.

Because other elements of the information processing device 6 except the language model generation unit 36 are the same as in the information processing devices 4 or 5, the elements and operations specific to this exemplary embodiment are described below, while descriptions similar to the third and fourth exemplary embodiments are omitted. Similarly to the information processing device 2 illustrated in FIG. 5, the information processing device 6 of this exemplary embodiment may be implemented by a computer which includes the CPU 610, the ROM 620, and the RAM 630.

The language model generation unit 36 generates a language model by using classification of a global context, a feature function for a trigger pair, and a feature function for an N-gram.

The information processing device 6 of the fifth exemplary embodiment configured as above can achieve the effects of the information processing devices 4 of the third exemplary embodiment and the information processing devices 5 of the fourth exemplary embodiment.

This is because the language model generation unit 36 of the information processing device 6 of the fifth exemplary embodiment generates a language model by using a feature function for a trigger pair and a feature function for an N-gram.

While the invention has been particularly illustrated and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2012-245003, filed on Nov. 7, 2012, the disclosure of which is incorporated herein in its entirety by reference.

The whole or part of the exemplary embodiments disclosed above can be described as, but not limited to, the following supplementary notes.

(Supplementary note 1)

An information processing device includes:
global context extraction means for identifying a word, a character, or a word string included in data as a specific word, and extracting a set of words included in at least a predetermined range extending from the specific word as a global context;

context classification means for classifying the global context based on a predetermined viewpoint, and outputting a result of classification; and

language model generation means for generating a language model for calculating a generation probability of the specific word by using the result of the classification.

(Supplementary note 2)

The information processing device according to supplementary note 1, includes:

context classification model generation means for generating a context classification model for indicating a relationship between the set of words and a class based on the predetermined viewpoint based on predetermined language data, wherein

the context classification means classifies the global context by using the context classification model.

(Supplementary note 3)

The information processing device according to supplementary note 2, wherein

the context classification model generation means generates a model for calculating a posterior probability of a class when a set of words are given by making a plurality of sets of words given class information training data.

(Supplementary note 4)

The information processing device according to supplementary note 2 or 3, wherein

the language model generation means uses a maximum entropy model by making a posterior probability of the class a feature function.

(Supplementary note 5)

The information processing device according to any one of supplementary notes 1 to 4, includes:

trigger feature calculation means for calculating a feature function for a trigger pair between a word included in the global context and the specific word, wherein

the language model generation means generates a language model by using the result of the classification and the feature function for the trigger pair.

(Supplementary note 6)

The information processing device according to any one of supplementary notes 1 to 5, includes:

feature function calculation means for calculating a feature function for an N-gram immediately preceding the specific word, wherein

the language model generation means generates a language model by using the result of the classification and the feature function for the N-gram.

(Supplementary note 7)

The information processing device according to any one of supplementary notes 1 to 6, includes:
trigger feature calculation means for calculating a feature function for a trigger pair between a word included in the global context and the specific word; and

feature function calculation means for calculating a feature function for an N-gram immediately preceding the specific word, wherein

the language model generation means generates a language model by using the result of the classification, the feature function for the trigger pair, and the feature function for the N-gram.

(Supplementary note 8)

An information processing method includes:

identifying a word, a character, or a word string included in data as a specific word, and extracting a set of words included in at least a predetermined range extending from the specific word as a global context;

classifying the global context based on a predetermined viewpoint, and outputting a result of classification; and

generating a language model for calculating a generation probability of the specific word by using the result of the classification.

(Supplementary note 9)

The information processing method according to supplementary note 8, includes:

generating a context classification model for indicating a relationship between the set of words and a class based on the predetermined viewpoint based on predetermined language data; and

classifying the global context by using the context classification model.

(Supplementary note 10)

The information processing method according to supplementary note 9, includes:

generating a model for calculating a posterior probability of a class when a set of words are given by making a plurality of sets of words given class information training data.

(Supplementary note 11) The information processing method according to supplementary note 9 or 10, includes:
using a maximum entropy model by making a posterior probability of the class a feature function.

(Supplementary note 12)

The information processing method according to any one of supplementary notes 8 to 11, includes:

calculating a feature function for a trigger pair between a word included in the global context and the specific word; and

generating a language model by using the result of the classification and the feature function for the trigger pair.

(Supplementary note 13)

The information processing method according to any one of supplementary notes 8 to 12, includes:

calculating a feature function for an N-gram immediately preceding the specific word; and

generating a language model by using the result of the classification and the feature function for the N-gram.

(Supplementary note 14)

The information processing method according to any one of supplementary notes 8 to 13, includes:

calculating a feature function for a trigger pair between a word included in the global context and the specific word;

calculating a feature function for an N-gram immediately preceding the specific word; and

generating a language model by using the result of the classification, the feature function for the trigger pair, and the feature function for the N-gram.

(Supplementary note 15)

A computer readable medium embodying a program, the program causing a computer to execute the processes of:

identifying a word, a character, or a word string included in data as a specific word, and extracting a set of words included in at least a predetermined range extending from the specific word as a global context;

classifying the global context based on a predetermined viewpoint and outputting a result of classification; and

generating a language model for calculating a generation probability of the specific word by using the result of the classification.

(Supplementary note 16)

The computer readable medium embodying the program according to supplementary note 15, the program causing the computer to execute the processes of:

generating a context classification model for indicating a relationship between the set of words and a class based on the predetermined viewpoint based on a predetermined language data; and

classifying the global context by using the context classification model.

(Supplementary note 17)

The computer readable medium embodying the program according to supplementary note 16, the program causing a computer to execute the process of:

calculating a posterior probability of a class when a set of words are given by making a plurality of sets of words given class information training data.

(Supplementary note 18)

The computer readable medium embodying the program according to supplementary note 15 or 16, wherein

the program uses a maximum entropy model by making a posterior probability of the class a feature function.

(Supplementary note 19)

The computer readable medium embodying the program according to any one of supplementary notes 15 to 18, the program causing a computer to execute the processes of:
calculating a feature function for a trigger pair between a word included in the global context and the specific word; and

generating a language model by using the result of the classification and the feature function for the trigger pair.

(Supplementary note 20)

The computer readable medium embodying the program according to any one of supplementary notes 15 to 19, the program causing a computer to execute the processes of:

calculating a feature function for an N-gram immediately preceding the specific word; and

generating a language model by using the result of the classification and the feature function for the N-gram.

(Supplementary note 21)

The computer readable medium embodying the program according to any one of supplementary notes 15 to 20, the program causing a computer to execute the processes of:

calculating a feature function for a trigger pair between a word included in the global context and the specific word;

calculating a feature function for an N-gram immediately preceding the specific word; and

generating a language model by using the result of the classification, the feature function for the trigger pair, and the feature function for the N-gram.

### INDUSTRIAL APPLICABILITY

The present invention can be applied to various applications that employ statistical language models.

For example, the present invention can improve accuracy of generated statistical language models used in the field of speech recognition, character recognition, and spelling check.

### REFERENCE SINGS LIST

1 Information processing device
2 Information processing device
3 Information processing device
4 Information processing device
5 Information processing device
6 Information processing device
9 Information processing device
10 Global context extraction unit
20 Global context classification unit
30 Language model generation unit
34 Language model generation unit
35 Language model generation unit
36 Language model generation unit
40 Context classification model generation unit
50 Trigger feature calculation unit
60 N-gram feature calculation unit
110 Language model training data storage unit
120 Context classification model training data storage unit
130 Context classification model storage unit
140 Language model storage unit
610 CPU
620 ROM
630 RAM
640 IO
650 Storage device
660 Input apparatus
670 Display apparatus
700 Storage medium
910 Global context extraction unit
920 Trigger feature calculation unit
930 Language model generation unit
940 Language model training data storage unit
950 Language model storage unit

What is claimed is:

1. An information processing device comprising:
a global context extraction unit which identifies a word, a character, or a word string included in data as a specific word, and extracts a set of words included in at least a predetermined range extending from the specific word as a global context;
a context classification unit which classifies the global context based on a predetermined viewpoint, and outputs a result of classification; and
a language model generation unit which generates a language model for calculating a generation probability of the specific word by using the result of the classification.

2. The information processing device according to claim 1, comprising:
a context classification model generation unit which generates a context classification model for indicating a relationship between the set of words and a class based on the predetermined viewpoint based on predetermined language data, wherein
the context classification unit classifies the global context by using the context classification model.

3. The information processing device according to claim 2, wherein
the context classification model generation unit generates a model for calculating a posterior probability of a class when a set of words are given by making a plurality of sets of words given class information training data.

4. The information processing device according to claim 2, wherein
the language model generation unit uses a maximum entropy model by making a posterior probability of the class a feature function.

5. The information processing device according to claim 1, comprising:
trigger feature calculation unit which calculates a feature function for a trigger pair between a word included in the global context and the specific word, wherein
the language model generation unit generates a language model by using the result of the classification and the feature function for the trigger pair.

6. The information processing device according to claim 1, comprising:
feature function calculation unit which calculates a feature function for an N-gram immediately preceding the specific word, wherein
the language model generation unit generates a language model by using the result of the classification and the feature function for the N-gram.

7. The information processing device according to claim 1, comprising:
trigger feature calculation unit which calculates a feature function for a trigger pair between a word included in the global context and the specific word; and
feature function calculation unit which calculates a feature function for an N-gram immediately preceding the specific word, wherein
the language model generation unit generates a language model by using the result of the classification, the feature function for the trigger pair, and the feature function for the N-gram.

8. An information processing method comprising:
identifying a word, a character, or a word string included in data as a specific word, and extracting a set of words included in at least a predetermined range extending from the specific word as a global context;
classifying the global context based on a predetermined viewpoint, and outputting a result of classification; and
generating a language model for calculating a generation probability of the specific word by using the result of the classification.

9. The information processing method according to claim 8, comprising:
generating a context classification model for indicating a relationship between the set of words and a class based on the predetermined viewpoint based on predetermined language data; and
classifying the global context by using the context classification model.

10. The information processing method according to claim 9, comprising:
generating a model for calculating a posterior probability of a class when a set of words are given by making a plurality of sets of words given class information training data.

11. The information processing method according to claim 9, comprising:
using a maximum entropy model by making a posterior probability of the class a feature function.

12. The information processing method according to claim 8, comprising:
calculating a feature function for a trigger pair between a word included in the global context and the specific word; and
generating a language model by using the result of the classification and the feature function for the trigger pair.

13. The information processing method according to claim 8, comprising:
calculating a feature function for an N-gram immediately preceding the specific word; and
generating a language model by using the result of the classification and the feature function for the N-gram.

14. The information processing method according to claim 8, comprising:
calculating a feature function for a trigger pair between a word included in the global context and the specific word;
calculating a feature function for an N-gram immediately preceding the specific word; and
generating a language model by using the result of the classification, the feature function for the trigger pair, and the feature function for the N-gram.

15. A computer readable non-transitory medium embodying a program, the program causing a computer to perform a method, the method comprising:
identifying a word, a character, or a word string included in data as a specific word, and extracting a set of words included in at least a predetermined range extending from the specific word as a global context;
classifying the global context based on a predetermined viewpoint and outputting a result of classification; and
generating a language model for calculating a generation probability of the specific word by using the result of the classification.

16. The method according to claim 15, comprising:
generating a context classification model for indicating a relationship between the set of words and a class based on the predetermined viewpoint based on a predetermined language data; and
classifying the global context by using the context classification model.

17. The method according to claim 16, comprising:
calculating a posterior probability of a class when a set of words are given by making a plurality of sets of words given class information training data.

18. The method according to claim 15, comprising:
using a maximum entropy model by making a posterior probability of the class a feature function.

19. The method according to claim 15, comprising:
calculating a feature function for a trigger pair between a word included in the global context and the specific word; and
generating a language model by using the result of the classification and the feature function for the trigger pair.

20. The according to claim 15, comprising:
calculating a feature function for an N-gram immediately preceding the specific word; and
generating a language model by using the result of the classification and the feature function for the N-gram.

21. (canceled)
